(19) United States
(12) Patent Application Publication
(10) Pub. No.: US 2015/0047255 A1
(43) Pub. Date: Feb. 19, 2015

(54) Cut Tree Watering Stand Device

(71) Applicant: Patrick K. Casdorph, Jacksonville, FL (US)

(72) Inventor: Patrick K. Casdorph, Jacksonville, FL (US)

(21) Appl. No.: 13/965,315

(22) Filed: Aug. 13, 2013

(51) Int. Cl. A01G 17/04

(52) U.S. Cl. CPC A01G 17/04
USPC 47/40.5

(57) ABSTRACT

A cut tree watering stand device facilitates watering of a cut tree held in an upright position by a tree stand. The device includes a stand defining an interior space configured for holding liquid. The stand is further configured for receiving a trunk of a cut tree wherein a bottom end of the cut tree is positioned in an interior space of the stand. A reservoir has a bottom wall and a peripheral wall extending upwardly from the bottom wall wherein the reservoir is configured to hold liquid. A receiver is coupled to a reservoir base. The receiver receives the reservoir in an inverted position supported on the reservoir base. A fluid supply line provides liquid from the reservoir to the interior space of the stand through the supply line.

### BACKGROUND OF THE DISCLOSURE

Field of the Disclosure

The disclosure relates to tree stand devices and more particularly pertains to a new tree stand device for facilitating watering of a cut tree held in an upright position by a tree stand.

### SUMMARY OF THE DISCLOSURE

An embodiment of the disclosure meets the needs presented above by generally comprising a stand defining an interior space configured for holding liquid. The stand is further configured for receiving a trunk of a cut tree wherein a bottom end of the cut tree is positioned in an interior space of the stand. A reservoir has a bottom wall and a peripheral wall extending upwardly from the bottom wall wherein the reservoir is configured to hold liquid. A receiver is coupled to a reservoir base. The receiver receives the reservoir in an inverted position supported on the reservoir base. A fluid supply line provides liquid from the reservoir to the interior space of the stand through the supply line.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a cut tree watering stand device according to an embodiment of the disclosure.

FIG. 2 is a top front side perspective view of an embodiment of the disclosure.

FIG. 3 is a bottom front side perspective view of an embodiment of the disclosure.

FIG. 4 is a cross-sectional view of an embodiment of the disclosure taken along line 4-4 of FIG. 1.

### DESCRIPTION OF THE PREFERRED EMBODIMENT

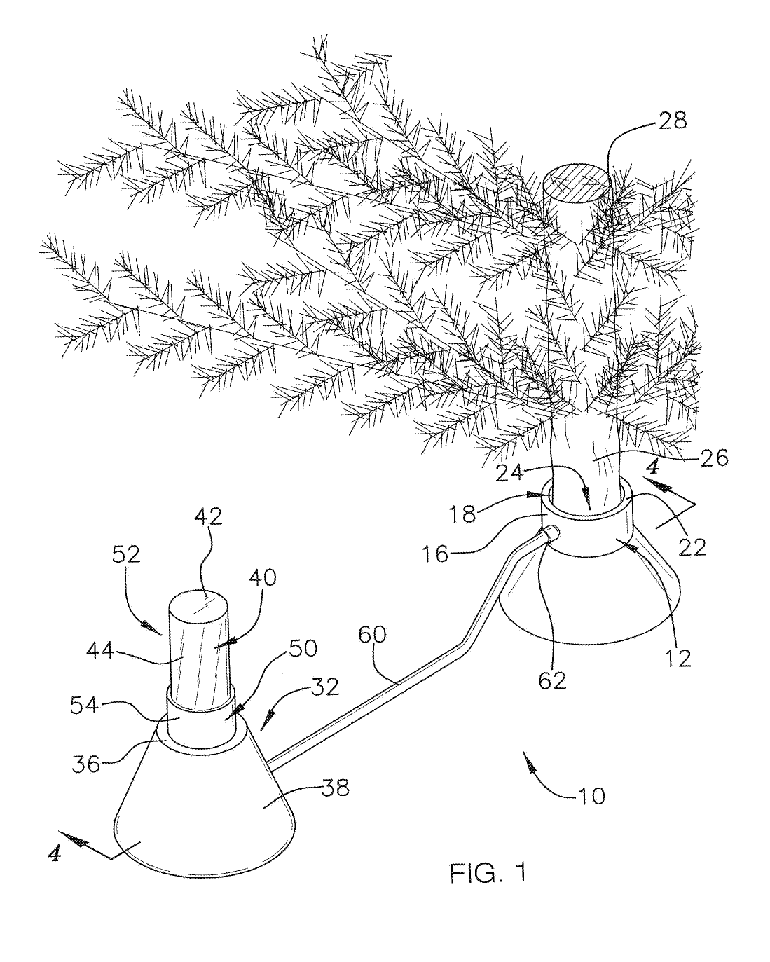

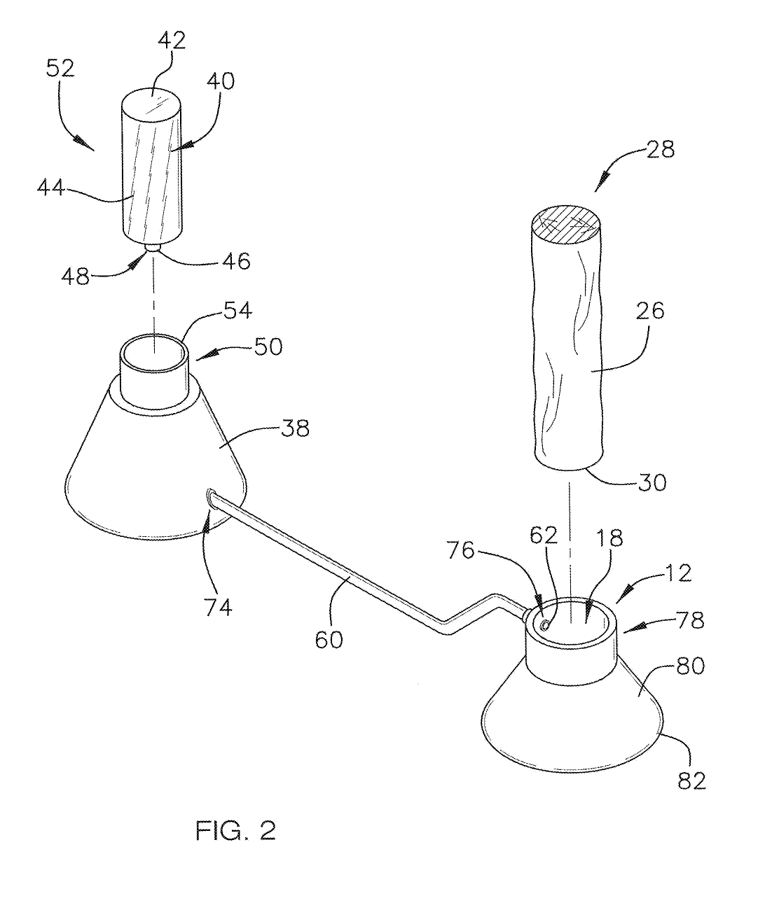

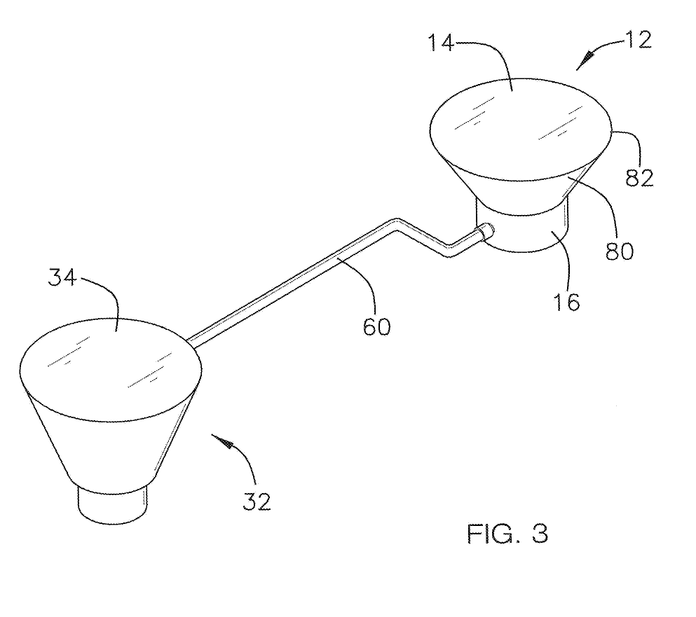

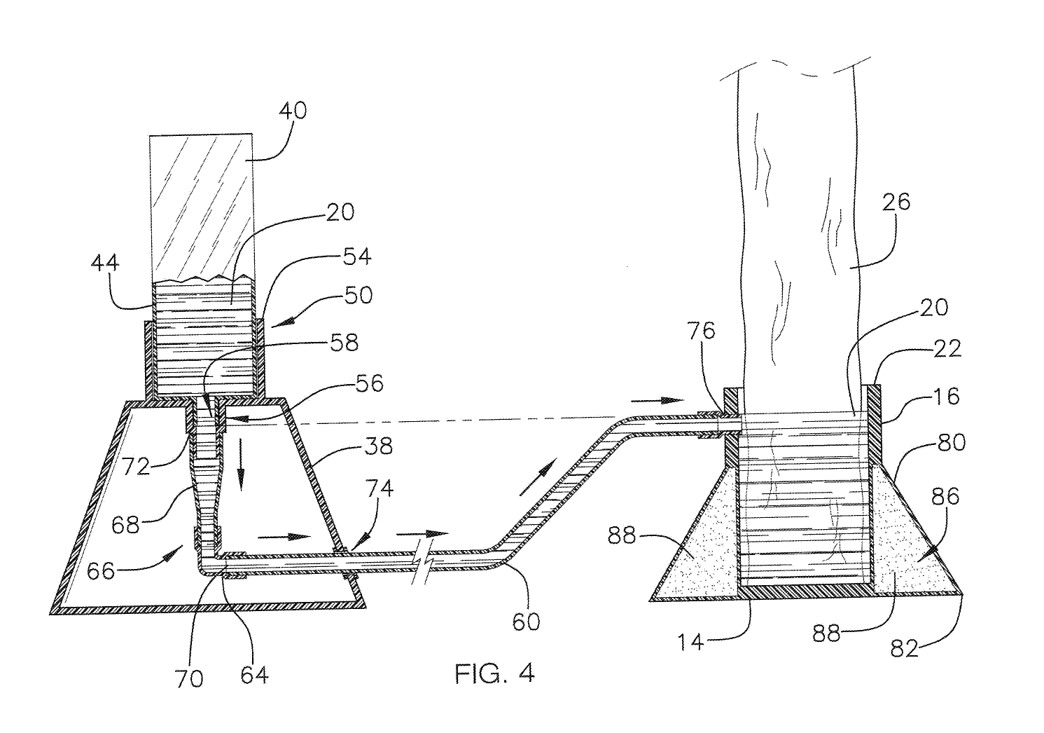

With reference now to the drawings, and in particular to FIGS. 1 through 4 thereof, a new tree stand device embodying the principles and concepts of an embodiment of the disclosure and generally designated by the reference numeral 10 will be described.

As best illustrated in FIGS. 1 through 4, the cut tree watering stand device 10 generally comprises a stand 12 having a base wall 14 and a perimeter wall 16 coupled to and extending upwardly from the base wall 14 defining an interior space 18 configured for holding liquid 20. An upper edge 22 of the perimeter wall 16 defines an opening 24 into the stand 12 configured for receiving a trunk 26 of a cut tree 28 wherein a bottom end 30 of the cut tree 28 is positioned in the interior space 18 of the stand 12. The trunk 26 of the cut tree 28 may be secured in a conventional manner to hold the cut tree 28 in an upright position. A reservoir base 32 is provided having a bottom surface 34, a top surface 36, and an exterior wall 38 coupled to and extending between the top surface 34 and the bottom surface 36. The reservoir base 32 may have a substantially trapezoidal diametric cross-sectional shape.

A reservoir 40 has a bottom wall 42 and a peripheral wall 44 extending upwardly from the bottom wall 42 wherein the reservoir 40 is configured to hold liquid 20. The reservoir 40 may be a conventional bottle. An upper edge 46 of the peripheral wall 44 defines an aperture 48 into the reservoir 40. A receiver 50 is coupled to the reservoir base 32. The receiver 50 is shaped to receive the reservoir 40 in an inverted position 52. The receiver 50 may have a support wall 54 extending upwardly relative to the top surface 36 of the reservoir base 32. A bottom portion 56 of the receiver 50 may be complementary in shape to an upper section 58 of the reservoir 40 to facilitate support of the reservoir 40 in the inverted position 52.

A fluid supply line 60 has a first end 62 coupled to and in fluid communication with the interior space 18 of the stand 12. The fluid supply line 60 has a second end 64 coupled to and in fluid communication with the receiver 50 wherein the reservoir 40 provides liquid 20 to the interior space 18 of the stand 12 through the supply line 60. A conduit 66 may be positioned in the reservoir base 32. The conduit 66 has a first section 68 substantially transverse to the bottom surface 34 of the reservoir base 32 and a second section 70 coupled to and extending from the first section 68. An upper end 72 of the first section 68 of the conduit 66 is fluidly coupled to the receiver 50 wherein the reservoir 40 supplies liquid 50 through the conduit 66. The second end 64 of the fluid supply line 60 may be coupled to the second section 70 of the conduit 66.

A passage 74 extends through the exterior wall 38 of the reservoir base 32. The fluid supply line 60 extends through the passage 74. Similarly, a hole 76 may extend through an upper portion 78 of the perimeter wall 16 of the stand 12. The first end 62 of the fluid supply line 60 is in fluid communication with the interior space 18 of the stand 12 through the hole 76. The hole 76 may be positioned in vertically spaced relationship above the passage 74 through the exterior wall 38 of the reservoir base 32 when the reservoir base 32 and the stand 12 are positioned on a level support surface.

An outer wall 80 may be coupled to and extend outwardly and downwardly from the perimeter wall 16 of the stand 12. A bottom edge 82 of the outer wall 80 may be coplanar with the base wall 14 of the stand 12 wherein the outer wall 80 provides lateral bracing for the stand 12. The bottom edge 82 of the outer wall 80 of the stand 12 may further be coupled to the base wall 14 of the stand 12 defining a chamber 86 extending around the perimeter wall 16 of the stand 12. A weighting material 88 such as sand or the like may be positioned in the chamber 86.

In use, the stand 12 supports the cut tree 28 in a substantially conventional manner. The reservoir base 32 is positioned in spaced relationship to the stand 12 providing access to the receiver 50 without interference from the cut tree 28. Liquid 20, more particularly water, may be poured into the receiver 50 wherein the water passes through to the interior space 18 of the stand 12 to help preserve the cut tree 28. The reservoir 40 may be filled and placed in the receiver 50 in the inverted position 52 wherein the liquid 20 in the reservoir 40 will continue to supply water to the cut tree 28 over an extended period of time. The reservoir 40 may be translucent to allow visual monitoring of the water level in the reservoir 40 to insure water is present in the interior space 18 of the stand 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A cut tree watering stand device comprising:
a stand having a base wall and a perimeter wall coupled to and extending upwardly from the base wall defining an interior space configured for holding liquid, an upper edge of the perimeter wall defining an opening into the stand configured for receiving a trunk of a cut tree wherein a bottom end of the cut tree is positioned in the interior space of the stand.
a reservoir base having a bottom surface, a top surface, and an exterior wall coupled to and extending between the top surface and the bottom surface,
a reservoir having a bottom wall and a peripheral wall extending upwardly from the bottom wall wherein the reservoir is configured to hold liquid, an upper edge of the peripheral wall defining an aperture into the reservoir.
a receiver coupled to the reservoir base, the receiver is shaped to receive the reservoir in an inverted position. and
a fluid supply line having a first end coupled to and in fluid communication with the interior space of the stand, the fluid supply line having a second end coupled to and in fluid communication with the receiver wherein the reservoir provides liquid to the interior space of the stand through the supply line.

2. The device of claim 1, further comprising an outer wall coupled to and extending outwardly and downwardly from the perimeter wall of the stand, a bottom edge of the outer wall is coplanar with the base wall of the stand wherein the outer wall provides lateral bracing for the stand.

3. The device of claim 2, further comprising the bottom edge of the outer wall of the stand is coupled to the base wall of the stand defining a chamber extending around the perimeter wall of the stand.

4. The device of claim 3, further comprising a weighting material is positioned in the chamber.

5. The device of claim 1, further comprising the reservoir base having a substantially trapezoidal diametric cross-sectional shape.

6. The device of claim 1, further comprising a conduit positioned in the reservoir base, the conduit having a first section substantially transverse to the bottom wall of the reservoir base, the conduit having a second section coupled to and extending from the first section, an upper end of the first section of the conduit is fluidly coupled to the receiver wherein the reservoir supplies liquid through the conduit, the second end of the fluid supply line is coupled to the second section of the conduit.

7. The device of claim 6, further comprising a passage extending through the exterior wall of the reservoir base, the fluid supply line extending through the passage.

8. The device of claim 7, further comprising a hole extending through an upper portion of the perimeter wall of the stand, the first end of the fluid supply line is in fluid communication with the interior space of the stand through the hole.

9. The device of claim 8, further comprising the hole is positioned in vertically spaced relationship above the passage through the exterior wall of the reservoir base.

10. A cut tree watering stand device comprising:
a stand having a base wall and a perimeter wall coupled to and extending upwardly from the base wall defining an interior space configured for holding liquid, an upper edge of the perimeter wall defining an opening into the stand configured for receiving a trunk of a cut tree wherein a bottom end of the cut tree is positioned in the interior space of the stand.
a reservoir base having a bottom surface, a top surface, and an exterior wall coupled to and extending between the top surface and the bottom surface, the reservoir base having a substantially trapezoidal diametric cross-sectional shape.
a reservoir having a bottom wall and a peripheral wall extending upwardly from the bottom wall wherein the reservoir is configured to hold liquid, an upper edge of the peripheral wall defining an aperture into the reservoir.
a receiver coupled to the reservoir base, the receiver is shaped to receive the reservoir in an inverted position.
a fluid supply line having a first end coupled to and in fluid communication with the interior space of the stand, the fluid supply line having a second end coupled to and in fluid communication with the receiver wherein the reservoir provides liquid to the interior space of the stand through the supply line.
an outer wall coupled to and extending outwardly and downwardly from the perimeter wall of the stand, a bottom edge of the outer wall is coplanar with the base wall of the stand wherein the outer wall provides lateral bracing for the stand, the bottom edge of the outer wall of the stand is coupled to the base wall of the stand defining a chamber extending around the perimeter wall of the stand.
a weighting material is positioned in the chamber.
a conduit positioned in the reservoir base, the conduit having a first section substantially transverse to the bottom wall of the reservoir base, the conduit having a second section coupled to and extending from the first section, an upper end of the first section of the conduit is fluidly coupled to the receiver wherein the reservoir supplies liquid through the conduit, the second end of the fluid supply line is coupled to the second section of the conduit.
a passage extending through the exterior wall of the reservoir base, the fluid supply line extending through the passage, and
a hole extending through an upper portion of the perimeter wall of the stand, the first end of the fluid supply line is in fluid communication with the interior space of the stand through the hole, the hole is positioned in vertically spaced relationship above the passage through the exterior wall of the reservoir base.
